(19) United States
(12) Patent Application Publication
(10) Pub. No.: US 2016/0265835 A1
(43) Pub. Date: Sep. 15, 2016

(54) CRYOGENIC FREEZER

(71) Applicant: John Brothers, Washington Twp., MI (US)

(72) Inventor: John Brothers, Washington Twp., MI (US)

(21) Appl. No.: 15/064,699

(22) Filed: Mar. 9, 2016

Related U.S. Application Data
(60) Provisional application No. 62/130,012, filed on Mar. 9, 2015.

(51) Int. Cl. F25D 23/00; A01N 1/02; F25D 23/02; F25D 3/10; F25D 17/06

(52) U.S. Cl. CPC F25D 23/006; F25D 3/105; F25D 17/06; F25D 23/026; A01N 1/0252; F25D 2323/00281

(57) ABSTRACT

A cryogenic freezer having a housing defining an interior chamber. A first and second fan are positioned in the chamber and are spaced apart from each other. At least one motor is drivingly connected to the fans so that, upon activation of the motor, the fans circulate air through the interior chamber in the same direction.

### CROSS-REFERENCE TO RELATED APPLICATIONS

This application claims priority of U.S. Provisional Application 62/130,012 filed Mar. 9, 2015, the contents of which are incorporated herein by reference.

### BACKGROUND OF THE INVENTION

I. Field of the Invention

The present invention relates to a cryogenic storage freezer for biological specimens.

II. Description of Related Art

There are many different situations where it is desirable to store biological specimens for long periods of time. Such biological specimens would include not only body fluids and organic matter, but also biological pharmaceutical agents.

In order to store such biological specimens, the biological specimens are placed in a storage freezer and lowered to a very low temperature, e.g. −100° Celsius or less. At such low temperatures, the biological specimens become completely frozen thus preventing deterioration of the biological specimen over time. Conventionally, liquid nitrogen is used to cool the biological specimens in the freezer, although other super-cooled liquids or gases may alternatively be used.

The previously known cryogenic freezers for storing biological specimens are relatively expensive not only to purchase but also to operate. The primary operation cost for the freezer resides in the cost of the liquid nitrogen which must be frequently introduced into the storage freezer in order to maintain the interior temperature of the storage freezer at the desired ultra-cold temperatures. Consequently, it is highly desirable to store as many biological specimens, typically contained within vials in the freezer in order to reduce the overall cost per vial of the cryogenic freezing and subsequent cost of the liquid nitrogen to maintain the biological specimens in a frozen condition.

In order to obtain viability of the biological specimens when the biological specimens are subsequently removed from the freezer and thawed for use, it is necessary to freeze the biological specimens in a predefined temperature profile and at a freezing rate defined by that profile. Consequently, it is highly desirable to obtain and maintain even cooling of the biological specimens throughout the entire contents of the cryogenic freezer regardless of whether the cryogenic freezer is only partially filled or completely filled with vials of biological specimens.

In order to create an even temperature distribution throughout the entire contents of the cryogenic freezer, not only during the cooling process, but also when the contents of the freezer are completely cooled, the previously known freezers have utilized a fan to circulate the gas from the liquid nitrogen within the interior of the freezer. However, in practice a single fan is unable to create sufficient gas flow within the interior of the cryogenic freezer, particularly when the cryogenic freezer is filled with biological specimens. When this occurs, some of the biological specimens are now frozen in accordance with the required temperature and rate profile which can adversely affect the vitality and viability of the biological specimens upon subsequent removal from the freezer and thawing.

### SUMMARY OF THE PRESENT INVENTION

A cryogenic storage freezer may include a housing that defines an interior (freezing) chamber. The housing may have a rectangular, or other, shape and it may be constructed of any suitable material, such as stainless steel. A pair of grates may be positioned in the interior chamber to divide the interior chamber into a pair of end chambers and a central chamber. Trays or other carrying apparatus for biological specimen (or the like) may be positioned in the interior chamber, such as in the central chamber, and a pair of fans driven by one or more motors may be positioned in the interior chamber and spaced apart from each other (with one, e.g., being in each end chamber).

An open top may be provided in the housing to provide access to the interior chamber. The open top may also be accessed by a lid that it is hingedly connected along one side to the housing. Opening and closing of the lid to provide access to the open top may also be assisted by the use of a power actuator connected to the lid.

A tank or other source of ultra-cold liquid gas may be fluidly connected to a liquid gas input on the housing. A control(s) may also be provided to operate the fans and the introduction of liquid as into the interior chamber from the tank or other source.

By proper control the introduction of an ultra-cold liquid gas (e.g., liquid nitrogen) into the interior chamber, coupled with the activation of the motors, the temperature of the central chamber containing biological specimen may be maintained in a highly even fashion so all the specimen contained therein will be cooled and maintained according to a desired temperature profile.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a perspective view illustrating preferred embodiment of the cryogenic storage freezer of the present invention;

FIG. 2 is a top view thereof;

FIG. 3 is a side partial sectional view thereof; and

FIG. 4 is an end view thereof.

### DETAILED DESCRIPTION OF A PREFERRED EMBODIMENT OF THE PRESENT INVENTION

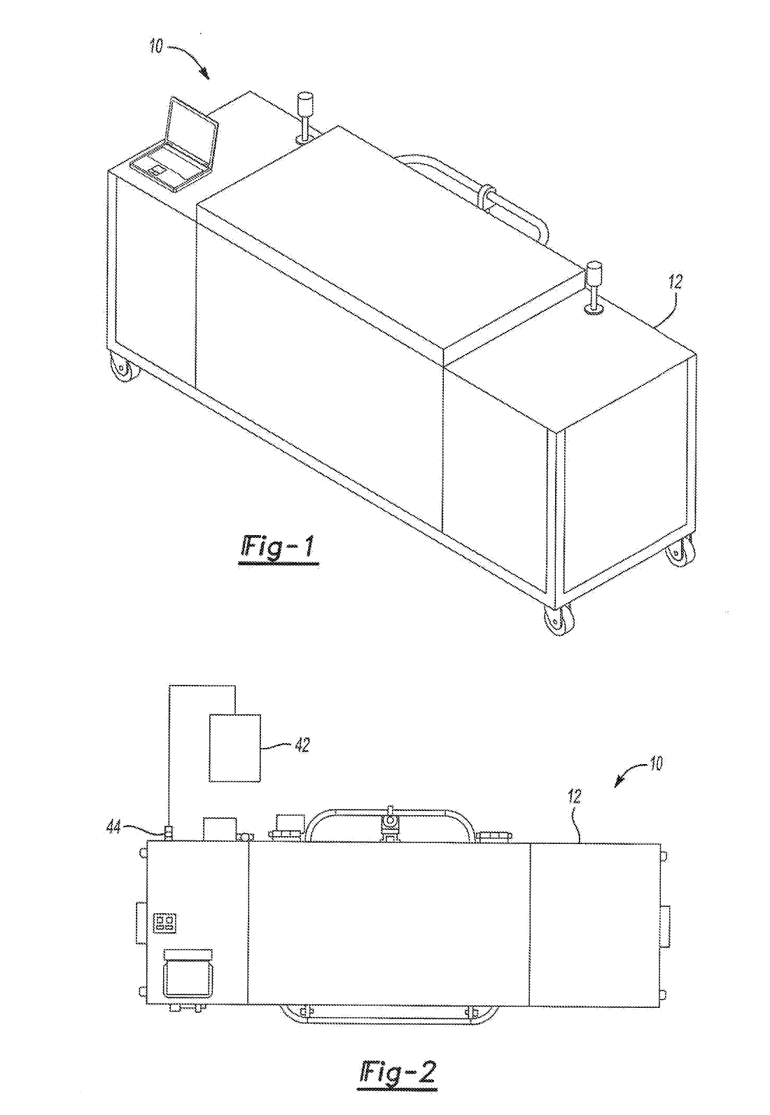

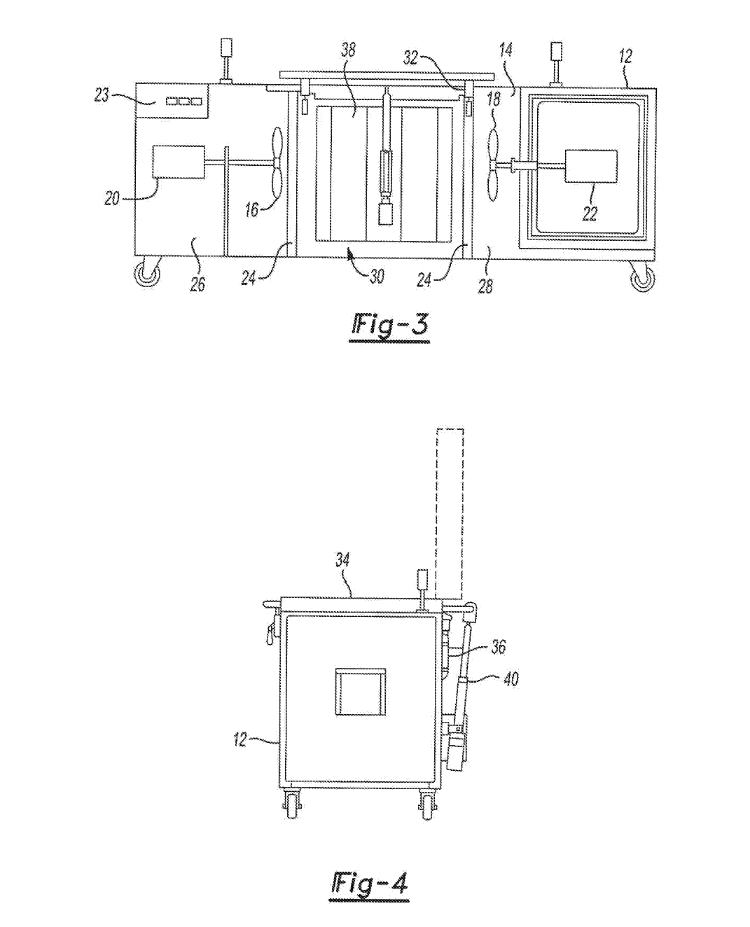

With reference first to FIGS. 1-3, a preferred embodiment of the cryogenic storage freezer 10 of the present invention is shown. The cryogenic freezer 10 is generally rectangular in shape having a housing 12 constructed of any suitable material, such as stainless steel. The housing 12 defines an interior freezing chamber 14 (FIG. 3).

As best shown in FIG. 3, a pair of spaced apart fans 16 and 18 are positioned within the chamber 14. A first motor 20 is drivingly connected to the first fan 16 to rotatably drive the fan 16 upon activation of the motor 20. Secondly, a second motor 22 is drivingly connected to the second fan 18 so that, upon activation of the second motor 22, the second motor 22 rotatably drives the second fan 18. Each, motor 20, 22 may be an electrically powered motor.

Although separate motors 20 and 22 are utilized to rotatably drive the fans 16 and 18, respectively, alternatively a single motor may be drivingly connected to both fans 16 and 18 so that, upon activation of the single motor, both fans 16 and 18 are rotatably driven.

A motor control 23 controls both the activation and speed of the motors 20 and 22. Furthermore, the fans 16 and 18 together with their associated motors 20 and 22 upon activation, circulate the air through the chamber 14 in the same direction, e.g. left to right as viewed in FIG. 3. Furthermore, this may be accomplished by either the selection of the right pitch of the two fans 16 and 18, or the direction of rotation of the fans 16 and 18.

A pair of grates 24 are preferably disposed within the housing 12 so that one grate 24 is positioned adjacent each fan 16 and 18. Furthermore, these grates 24 divide the interior chamber 14 into two end chambers 26 and 28, and a central chamber 30 in between the two grates 24. Furthermore, the fans 16 and 18 are contained within the end chambers 26 and 28, respectively. In practice, the grates 24 enable free gas flow through the interior chamber 14 of the housing 12 and yet isolate the fans 16 and 18 from the central chamber 30 for safety reasons.

With reference now to FIGS. 3 and 4, the central chamber 30 has an open top 32. A lid 34 is then pivotally connected by hinges 36 to the housing 12 to allow the lid 34 to move between a closed position, illustrated in solid line in FIG. 4, in which the lid 34 overlies the open top 32 of the central chamber 30 and generally closes the open top 32, and an open position, illustrated in phantom line in FIG. 4. In its open position, the lid 34 provides access to the central chamber 30 through the open top 32 so that trays 38 (FIG. 3) containing biological specimens and the like may be inserted into and removed from the central chamber 30. A power actuator 40 (FIG. 4) is pivotally connected to the lid 34. Actuation of the actuator 40 moves the lid 34 between its open and closed positions.

In practice, a tank or source 42 (FIG. 2) of ultra-cold liquid gas, such as liquid nitrogen, is fluidly connected to a liquid gas input 44 on the housing 12. The control 23 controls not only the operation of the motors 20 and 22, but also the introduction of liquid nitrogen from the tank 42 into the interior chamber 14 of the freezer 10.

With the lid 34 in its open position, the tray 38 containing biological specimens is positioned within the central chamber 30 of the housing 12. The lid 34 is then closed.

By proper control of the introduction of the liquid nitrogen gas into the interior chamber 14, coupled with the activation of the motors 20 and 22, the temperature of the entire central chamber 30 may be maintained in a highly even fashion so that all the specimens contained within the tray will be cooled according to the desired profile. Any conventional means, furthermore, may be used to control the input of the liquid nitrogen gas into the interior chamber 14.

From the foregoing, it can be seen that the present invention provides a cryogenic storage freezer which achieves very even cooling and high precision profile cooling of all of the specimens contained within a specimen tray. Having described my invention, however, many modifications thereto will become apparent to those skilled in the art to which it pertains without deviation from the spirit of the invention as defined by the scope of the appended claims.

I claim:

1. A cryogenic freezer comprising:
a housing having an interior chamber,
a first and second fan positioned in said chamber and spaced apart from each other,
at least one motor drivingly connected to said fans so that, upon activation of said at least one motor, said fans circulate air through said interior chamber in the same direction.

2. The invention as defined in claim 1 wherein said housing is rectilinear in shape.

3. The invention as defined in claim 2 wherein said fans are positioned adjacent opposite ends of said housing chamber.

4. The invention as defined in claim 3 and comprising a pair of grates extending across said interior chamber and forming a central chamber and two end chambers in the housing, one of said fans being positioned in each of said end chambers.

5. The invention as defined in claim 3 and comprising a motor control which controls the activation and speed of said at least one motor.

6. The invention as defined in claim 1 wherein said at least one motor comprises a first motor drivingly connected to said first fan and a second motor drivingly connected to said second fan.

7. The invention as defined in claim 6 wherein said first and second motors each comprises an electrically powered motor.

8. The invention as defined in claim I wherein said housing has an open top and comprising a lid pivotally attached to said housing and movable between a closed position in winch said lid overlies and closes said open top of said housing and an open position in which one side of said lid is pivoted away from said housing to provide access to said interior chamber.

9. The invention as defined in claim 8 and comprising a powered actuator connected between said housing and said lid for moving said lid between said open and said closed positions.

10. The invention as defined in claim 1 and comprising a source of liquid as selectively fluidly coupled to said housing chamber.

11. The invention as defined in claim 10 wherein said gas comprises liquid nitrogen.
